(19) United States
(12) Patent Application Publication
(10) Pub. No.: US 2026/0095705 A1
(43) Pub. Date: Apr. 2, 2026

(54) METHOD FOR TUNING ANC BASED ON HEARING THRESHOLD LEVEL AND APPARATUS FOR TUNING ANC BASED ON HEARING THRESHOLD LEVEL

(71) Applicant: Harman International Industries, Incorporated, Stamford, CT (US)

(72) Inventors: Peijun Li, BeijingShenzhen (CN); Yulian CHEN, Shenzhen (CN)

(21) Appl. No.: 19/322,540

(22) Filed: Sep. 8, 2025

(30) Foreign Application Priority Data
Sep. 27, 2024 (CN) 2024113716314

(51) Int. Cl. H04R 25/00

(52) U.S. Cl. CPC H04R 25/505; H04R 2460/01

(57) ABSTRACT

The present inventive subject matter provides a method for tuning ANC based on a hearing threshold level of a user and an apparatus for tuning ANC based on a hearing threshold level of a user, wherein hearing threshold level data of the user is obtained by performing a hearing test on the user, and an ANC filter is tuned based on the hearing threshold level data of the user, so that the user obtains more

### TECHNICAL FIELD

The present inventive subject matter relates to audio processing, and more specifically, the present inventive subject matter relates to a method for tuning active noise cancellation (ANC) based on a hearing threshold level of a user and a system thereof.

### BACKGROUND AND SUMMARY

It can be understood by those skilled in the art that a sound is generated by the vibration of a sound-emitting body. Then, the sound propagates through a medium in the form of a wave. The propagation of the sound in the medium will generate a sound wave. The active noise cancellation (ANC) technology is a denoising technology that neutralizes an external sound or noise by generating an anti-phase wave of the original noise. Theoretically, when the sound wave generated by the noise cancellation system has a consistent amplitude with a to-be-canceled noise, and the phase difference is exactly 180°, the noise can be completely canceled.

However, when an ANC filter is designed, it is very difficult to ensure that the generated sound wave satisfies all required phase and amplitude conditions within a range of a full frequency band. Therefore, it is necessary to balance the phase and amplitude of the anti-phase wave, so that the ANC performance will become better within some frequency ranges, but may become worse in other frequency ranges.

Therefore, there is a need for a technical solution that can tune ANC based on hearing threshold features of a user, can combine a hearing test of the user with optimization of the ANC filter configuration, and automatically updates the ANC filter configuration using an adaptive ANC algorithm, thereby obtaining personalized optimal ANC performance.

According to one aspect of the present disclosure, a method for tuning ANC based on a hearing threshold level of a user is provided. The method performs a hearing test on a particular user to obtain hearing threshold level data of the user. The method further sets or tunes an ANC filter in a personalized manner based on the measured hearing threshold level data of the user, so that the user can obtain better ANC effects.

According to another aspect of the present disclosure, a non-transitory computer-readable medium comprising an instruction is provided, wherein the instruction, when executed by one or more processors, causes the one or more processors to implement the method for setting or tuning an ANC filter based on a hearing threshold level of a user as provided by the present inventive subject matter.

### DESCRIPTION OF DRAWINGS

These and/or other features, aspects, and advantages of the present invention will be better understood after reading the following detailed description with reference to the drawings, throughout which same characters represent same components, wherein:

FIG. 1 shows a schematic diagram of ANC performance of different ANC filter configurations as an example;

FIG. 2 shows a schematic diagram of a difference in hearing threshold levels of different users in different frequency ranges as an example;

FIG. 3 shows a flowchart of a method for tuning ANC based on a hearing threshold level of a user according to one or more embodiments of the present inventive subject matter as an example;

FIG. 4 shows a schematic diagram of a hearing threshold level of a user at each frequency point according to one or more embodiments of the present inventive subject matter as an example;

FIG. 5 shows a schematic diagram of ANC effects corresponding to a pre-modulated invokable ANC filter according to one or more embodiments of the present inventive subject matter as an example; and

FIG. 6 shows a block diagram of an apparatus for tuning ANC based on a hearing threshold level of a user according to one or more embodiments of the present inventive subject matter as an example.

### DETAILED DESCRIPTION

The description of various embodiments is given below for illustrative purposes, but is not intended to be exhaustive or limit the disclosed embodiments. Many modifications and alterations will be apparent to those of ordinary skills in the art without departing from the scope and spirit of the described embodiments.

A hearing threshold (e.g., a pure tone hearing threshold) reflects a minimum sound pressure level at which a human ear can just hear a sound in an interference-free quiet environment. Therefore, the hearing threshold refers to a lowest sound pressure level that can be heard by a particular person. In addition, the hearing threshold level (hearing level) is used to represent the number of decibels that a hearing threshold of a human ear at a frequency is higher than a normal hearing threshold, can express the degree of hearing loss of the human ear, is in a unit of dB, and is frequency-related.

In a hearing test, a person whose hearing threshold level does not exceed 10 dB within a test frequency range (e.g., 250 kHz to 8 kHz) is usually referred to as an otologically normal person. However, in daily life, under normal circumstances, people may also suffer from hearing loss due to age, such as presbycusis; or may suffer from hearing loss due to community noises, such as socioacusis; and in addition, may also suffer from hearing loss due to occupational noises, such as noise-induced deafness. As mentioned above, the degree of hearing loss of people is frequency-related.

The present inventive subject matter provides a method for tuning ANC based on a hearing threshold level of a user. The method first performs a hearing test on a particular user to obtain a hearing threshold level of the user, then sets ANC filter configuration or tunes parameters of an ANC filter based on the measured hearing threshold level of the user, and executes an adaptive ANC algorithm, thereby optimizing the ANC performance and effects for the particular user.

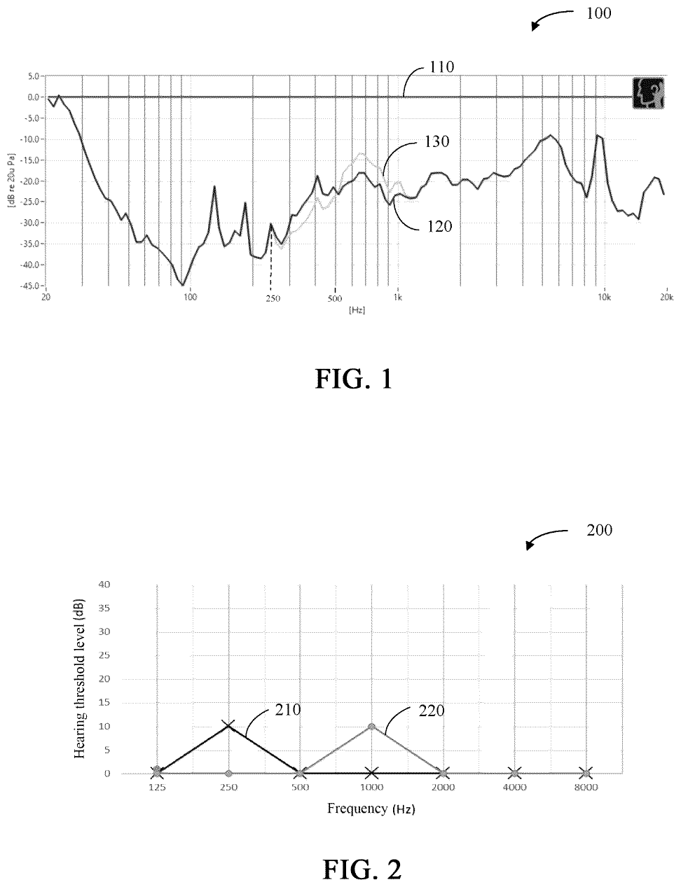

FIG. 1 shows a schematic diagram 100 of ANC performance of different ANC filter configurations as an example. In the example shown in FIG. 1, an external noise that can be heard by a user before wearing an ANC earphone is as shown in a noise curve 110. The external noise shown in FIG. 1 has been zeroed, so that its noise curve 110 can be seen to present a straight line.

After ANC function of the earphone is enabled, as shown in FIG. 1, a first ANC filter configuration can be used to reduce a sound pressure level of a noise that can be heard by a user to a level as shown in the dark-colored noise curve 120, while a second ANC filter configuration can be used to reduce the noise that can be heard by the user to a level as shown in the light-colored noise curve 130. It can be understood that after using the noise cancellation function, the lower the noise that is heard by the user is, the better the noise cancellation performance and effects are. Therefore, as can be seen from FIG. 1, the user hears a lower external noise within a frequency range of 500 Hz-1 kHz when an ANC filter of the first ANC configuration is used than when an ANC filter of the second configuration is used. Comparatively, the user hears a lower noise within a frequency range of 125 Hz-500 Hz when the ANC filter of the second configuration is used than when the ANC filter of the first configuration is used. That is, for a user with more sensitive hearing within the frequency range of 125 Hz-500 Hz than within the frequency range of 500 Hz-1 kHz, a better noise cancellation experience can be obtained by using the ANC filter of the second configuration. Otherwise, a better noise cancellation experience can be obtained by using the ANC filter of the first configuration.

FIG. 2 shows a schematic diagram 200 of a difference in hearing threshold levels of different users in different frequency ranges as an example. In the example of FIG. 2, a hearing threshold level of user 1 at each frequency point has been marked with “x” in FIG. 2, and the hearing threshold level of the user 1 at each frequency point can be connected to represent a hearing threshold level curve 210 of the user 1. As can be seen from FIG. 2, a hearing threshold of the ears of the user 1 at 250 Hz is 10 dB higher than a normal hearing threshold, so that it can be determined that the ears of the user 1 have hearing loss at 250 Hz, thereby determining that the user has better hearing in the frequency range of 500 Hz-1 kHz than in the frequency range of 250 Hz-500 Hz.

Therefore, in combination with the ANC filters of the two configurations in FIG. 1, the user 1 can choose to use the ANC filter of the first configuration, which has the noise cancellation performance as shown in the noise curve 120 in FIG. 1, that is, better noise cancellation effects can be achieved in the frequency range of 500 Hz-1 kHz, so that the user 1 can obtain better ANC effects in the frequency range of 500 Hz-1 kHz in which the user has better hearing.

In addition, returning to reference FIG. 2, a hearing threshold level of user 2 at each frequency point has been marked with “●” in FIG. 2, and the hearing threshold level of the user 2 at each frequency point can be connected to represent a hearing threshold level curve 220 of the user 2. As can be seen from FIG. 2, a hearing threshold of the ears of the user 2 at 1 kHz is 10 dB higher than the normal hearing threshold, so that it can be determined that the user 2 has better hearing in the frequency range of 250 Hz-500 Hz than in the frequency range of 500 Hz-1 kHz.

Therefore, in combination with the ANC filters of the two configurations of in FIG. 1, the user 2 can choose to use the ANC filter of the second configuration, which has the noise cancellation performance as shown in the noise curve 130 in FIG. 1, so that the user 2 can obtain better ANC effects in the frequency range of 250 Hz-500 Hz in which the user has better hearing.

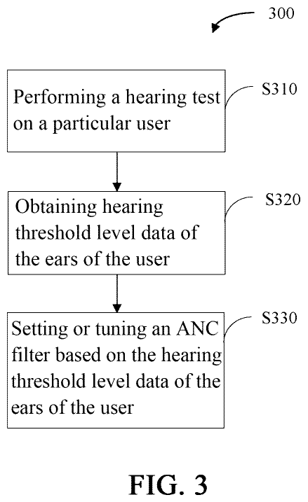

FIG. 3 shows a flowchart 300 of a method for tuning ANC based on a hearing threshold level of a user according to one or more embodiments of the present inventive subject matter as an example. As shown in FIG. 3, in step S310, a hearing test is first performed on the user. The hearing test can be performed on ears of a particular user within a frequency range.

In the method of the present inventive subject matter, the hearing test on the user may be a subjective test. In one or more embodiments, a test tone at different frequencies is first broadcasted to the user. For example, the test tone can be broadcasted at several frequency points within a hearing frequency range respectively. The test tone may be broadcasted to the ears of the user through a transducer (such as an earphone or a speaker). In some examples, the hearing test may be performed in accordance with GB/T 7341 or IEC 60645 standard, which describes a hearing test for human ears within a frequency range of 125 Hz-8 kHz. For example, the test tone may be broadcasted at 7 frequency points, namely, 125 Hz, 250 Hz, 500 Hz, 1 kHz, 2 kHz, 4 kHz, and 8 kHz, to test auditory responses of the ears of the user at different frequency points. The test tone may be broadcasted to the user via various types of transducers. For example, the test tone may be broadcasted to the user via an earphone. For example, the test tone may be broadcasted to the user via a speaker.

In one or more embodiments of the present inventive subject matter, the hearing test result may be obtained from a feedback from the user on the test tone heard by the user as a testee. The hearing test response of the user at each frequency point may be obtained from, for example, a feedback from the user on a hearing threshold level of the test tone that can be heard by the user at different frequencies. In some examples, the feedback from the user on the test tone that is heard (or unheard) by the user can be obtained through a user input. For example, an application (App) may be set in a user device and a corresponding user interface may be arranged therein, so that the user can provide a manual feedback on the test tone broadcasted to the user through an input via the App.

In some examples, for the test tone broadcasted at a particular frequency point, the user can provide a feedback on his perception degree of the test tone, for example, the magnitude of the sound pressure level or the clarity. The user can provide a feedback on his perception of the test tone heard by the user. For example, when the test tone at a frequency is broadcasted, the test tone is broadcasted at a sound pressure level that gradually decreases from a normal sound pressure level. The user can provide a feedback through the App of his user device on whether his perception of the heard test tone is, e.g., clear, ordinary, undistinguished, or unhearable. For example, the user interface of the application may present the above options for perception on a current test tone for the user to make a corresponding selection. Then, in step S320, hearing threshold level data of the ears of the user is obtained. The system can record a sound pressure level at which the user exactly fails to hear the test tone at different frequency points, reflecting hearing threshold levels of the user at that frequency point, thereby measuring the hearing loss of the user at the different frequency points.

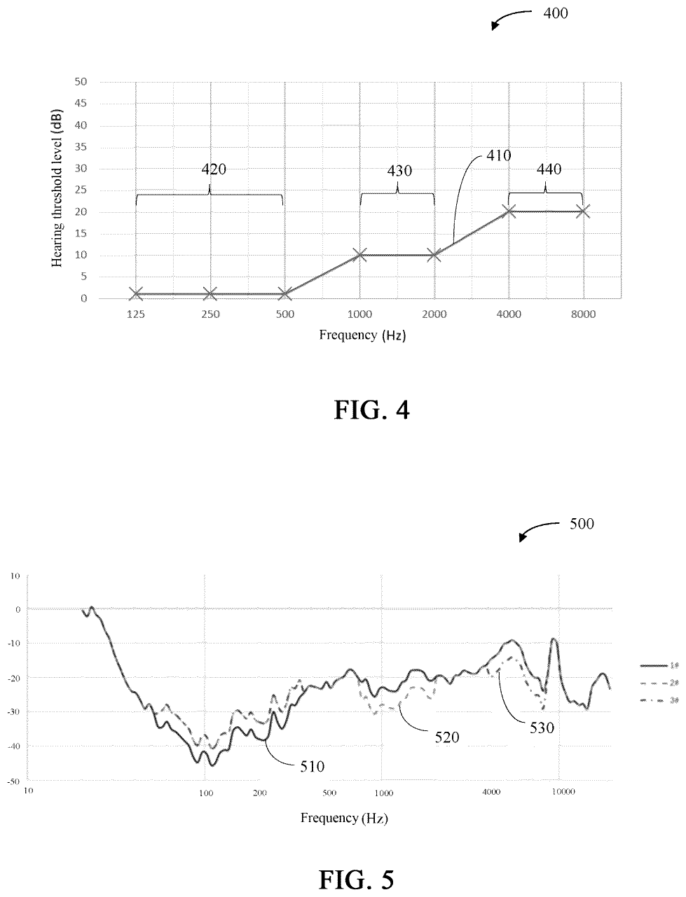

FIG. 4 schematically shows a schematic diagram 400 of a hearing threshold level of user 3 at each frequency point according to one or more embodiments of the present inventive subject matter. As can be seen from the above description in accordance with FIG. 2, the hearing threshold level of the user 3 at each frequency point is marked with “x” in FIG. 4, and the hearing threshold level of the user 3 at each frequency point can be connected to represent a hearing threshold level curve 410 of the user 3. As can be seen from FIG. 4, the hearing threshold level of the ears of the user 3 at the frequency points of 125 Hz, 250 Hz, and 500 Hz is 0 dB, that is, the user 3 has very sensitive hearing in a frequency range 420 of 125 Hz to 500 Hz. A hearing threshold of the user 3 is 10 dB higher than a normal hearing threshold at frequency points of 1 kHz and 2 kHz, indicating that the ears of the user 3 have normal hearing in a frequency range 430 of 1 kHz to 2 kHz, and is 20 dB higher than the normal hearing threshold at frequency points of 4 kHz and 8 kHz, indicating that the ears of the user 3 may have hearing loss in a frequency range 440 of 4 kHz to 8 kHz.

Therefore, the hearing test result of the user 3 can be obtained based on a subjective feedback from the user 3 on the test tone broadcasted in the hearing test. In this example, the hearing test result of the user 3 is as follows:

| | |
|---|---|
| Audio test point | Hearing threshold level (hearing loss) |

| | | | |
|---|---|---|---|
| 125 | Hz | 0 | dB |
| 250 | Hz | 0 | dB |
| 500 | Hz | 0 | dB |
| 1 | kHz | 10 | dB |
| 2 | kHz | 10 | dB |
| 4 | kHz | 20 | dB |
| 8 | kHz | 20 | dB |

Returning to FIG. 3, in step S330, an ANC filter is set based on a hearing threshold level of the user. When the hearing threshold level of the user is obtained, what frequency range of noise to which the user is insensitive can be known. In this way, the ANC filter can be set. In addition, since an adaptive ANC algorithm can automatically update the ANC filter configuration, the hearing test of the user may be further combined with the adaptive ANC to establish the adaptive ANC algorithm based on the hearing threshold level of the user to obtain best ANC performance, so that the user obtains better ANC effects in a frequency range in which the user has sensitive hearing.

The method provided by the present inventive subject matter is based on setting of an optimized ANC filter in the frequency range in which the user has sensitive hearing, for example, allowing the adaptive ANC algorithm to automatically tune the ANC filter in the frequency range in which the user has sensitive hearing to obtain better ANC performance. Therefore, first, hearing level or sensitivity of the user may be ranked based on the hearing threshold level data of the user obtained as described above, to find the frequency range in which the user has sensitive hearing. For example, different priorities are set based on the degrees of hearing loss of the user in various frequency ranges. In some examples, the frequency range in which the user has sensitive hearing is set to have a high priority.

For example, referring to the feedback from the user 3 in the description of FIG. 4, the hearing threshold level data of the ears of the user 3 may be: the user 3 has very sensitive hearing in the frequency range 420 of 125 Hz-500 Hz (priority 1 for performance optimization of the ANC filter in the frequency range 420 is set to high), the user 3 has ordinary hearing in the frequency range 430 of 1 kHz-2 kHz (priority 2 is set to medium), and the user 3 has impaired hearing in the frequency range 440 of 4 kHz-8 kHz (the hearing threshold level exceeds 10 dB, and priority 3 is set to low). Therefore, for the user 3, the priorities of the three frequency ranges may be ranked in the performance optimization of the ANC filter configurations as follows:
Frequency range 420>frequency range 430>frequency range 440

Accordingly, based on such priorities, the ANC filter can be optimized by setting the parameters of the ANC filter suitable for the user 3, so that the user 3 obtains better ANC effects. For example, an ANC filter may be designed for the user 3 by considering preferentially optimizing the noise cancellation performance in the frequency range 420 of 125 Hz-500 Hz, then optimizing the noise cancellation in the frequency range 430 of 1 kHz-2 kHz, and finally optimizing the noise cancellation in the frequency range 440 of 4 kHz-8 KHz.

In some examples, different optimization weights may be set for the ANC filter in different frequency ranges, with a larger weight value applied to a frequency range with a higher priority and a smaller weight value applied to a frequency band with a lower priority. For example, in the example of FIG. 4, a high weight value, such as 60%, may be set for the frequency range 420 of 125 Hz-500 Hz; a weight value, such as 35%, may be set for the frequency range 430 of 1 kHz-2 kHz, and a low weight value, such as 5%, may be set for the frequency range 440 of 4 kHz-8 KHz.

For the optimization of the ANC filter configurations, in some examples, ANC parameters matching a hearing condition of a particular user may be invoked. This method requires pre-modulating a plurality of sets of different ANC filter parameters, and storing them in, e.g., a storage device of the earphone. Each set of stored ANC parameters is actually a set of ANC filters. A pre-configured ANC library composed of a plurality of invokable ANC filters is stored in the storage device of the earphone, wherein each ANC filter parameter includes, for example, a filter type, a filter gain, a frequency point, and a quality factor. Each of the ANC filter functions to process a noise signal picked up by a microphone to generate a denoised signal matching a to-be-canceled noise signal, for example, generate a denoised signal with an opposite phase and same amplitude and same frequency as the noise signal, and broadcast it via the speaker, so as to achieve the effect of noise cancellation by canceling and neutralizing the noise signal.

FIG. 5 shows a schematic diagram 500 of an ANC effect corresponding to a pre-modulated invokable ANC filter according to one or more embodiments of the present inventive subject matter as an example. FIG. 5 comprises three pre-modulated ANC filters, namely ANC 1 with an ANC noise cancellation curve 510 represented by a solid line, ANC 2 with an ANC noise cancellation curve 520 represented by a dotted line, and ANC 3 with an ANC noise cancellation curve 530 represented by a dashed line.

In some examples, for example, relative to the hearing condition of the user 3 in the example of the above reference FIG. 4, in this example, the priority of ANC performance optimization determined for the user 3 is in the frequency range of 125 Hz-500 Hz>in the frequency range of 1 kHz-2 kHz>in the frequency range of 4 kHz-8 kHz. Therefore, based on weight values assigned to these frequency ranges in this example, ANC 1 can be preferentially selected for ANC noise cancellation at a frequency point within 125 Hz-500 Hz with a weight of 60%, so as to obtain better ANC performance of the ANC noise cancellation curve 510 in the frequency range of 125 Hz-500 Hz, or ANC 2 can be preferentially selected for ANC noise cancellation at a frequency point within 1 kHz-2 kHz with a weight of 35%, so as to achieve better ANC effects of the ANC noise cancellation curve 520 in the frequency range of 1 kHz-2 kHz, or additionally, ANC 3 can be preferentially selected for noise cancellation at a frequency point within 4 kHz-8 kHz with a weight of 5%, so as to achieve better ANC effects of the ANC noise cancellation curve 530 in the frequency range of 4 kHz-8 KHz.

In some other examples, the ANC optimization may also be implemented by automatically updating the ANC filter configurations using a real-time adaptive ANC algorithm based on least mean square error (LMS). For example, new matching ANC parameters can be obtained through iterative operations using the adaptive ANC algorithm. The advantage of this method is that it is not necessary to pre-customize or pre-set the ANC parameters.

In these examples of the present inventive subject matter, the hearing threshold level of the user is obtained through testing, and is not a preset parameter. The testing to obtain the hearing threshold level of the user functions to point out the direction of improving the ANC experience, which is a basis for algorithm optimization actions. Therefore, in the method provided by the present inventive subject matter, as long as the hearing threshold level of the user is obtained and the hearing threshold level data is transmitted to the system, the system can automatically complete the division of frequency band priorities and the optimization of the ANC effects.

As mentioned above, the method provided by the present inventive subject matter can be implemented via different types of earphones. For example, these different types of earphones may include, e.g., an on-ear headphone, a circumaural headphone, an in-ear earphone, and a bone conduction headset. In some examples, those skilled in the art can imagine that the method provided by the present inventive subject matter may also be used in other transducers, such as a speaker.

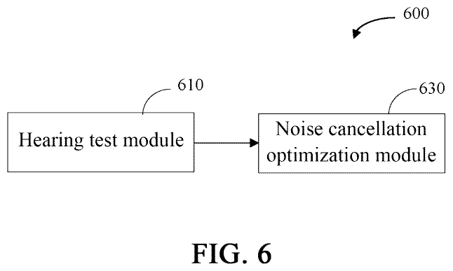

FIG. 6 shows a block diagram 600 of an apparatus for tuning ANC based on a hearing threshold level of a user according to one or more embodiments of the present inventive subject matter as an example. The apparatus for tuning ANC based on a hearing threshold level of a user provided by the present inventive subject matter can be implemented by a user as described in reference FIG. 3. As shown in FIG. 6, a hearing test module 610 can be configured to perform a hearing test on the user. The hearing test can be performed on ears of a particular user within a frequency range. In some examples, the hearing test module 610 can be configured to first broadcast a test tone at different frequencies to the user. For example, the test tone can be broadcasted at several frequency points within an auditory frequency range respectively, to test auditory responses of the ears of the user at different frequency points. The test tone may be broadcasted to the user via various types of transducers.

The hearing test result can be fed back to the hearing test module 610 by providing, via the user as the testee, a feedback on the test tone heard by the user. The hearing test response of the user at each frequency point may be obtained from, for example, a feedback from the user on a hearing threshold level of the test tone that can be heard by the user at different frequencies. In some examples, the feedback from the user on the test tone that is heard (or unheard) by the user can be obtained through a user input. For example, an application (App) may be set in a user device and a corresponding user interface may be arranged therein, so that the user can provide a manual feedback on the test tone broadcasted to the user through an input via the App.

As shown in FIG. 6, the noise cancellation optimization module 630 can be configured to read the hearing test result of the particular user from the hearing test module 610, thereby obtaining hearing threshold level data of the ears of the user. The noise cancellation optimization module 630 can be further configured to set an ANC filter based on a hearing threshold level of the user. For example, when the hearing threshold level of the user is obtained, priorities of frequency ranges of the hearing test of the user can be ranked based on the hearing sensitivity, so that the frequency ranges in which the user has more sensitive hearing can be optimized preferentially. In this way, the ANC filter can be optimally set.

Elements in various embodiments of the modules, elements and components used to implement the method provided by the present inventive subject matter can be manufactured as one or more electronic devices residing on a same chip or in a chipset, including but not limited to an array of fixed or programmable logic elements (such as transistors or gates, etc.). One or more elements in the various embodiments of the device described herein may be further implemented in whole or in part as one or more instruction sets, which may be arranged to be executed on one or more fixed or programmable logic element arrays (e.g., microprocessors, embedded processors, IP cores, digital signal processors, FPGAs, ASSPs, and ASICs).

The apparatus for tuning ANC based on a hearing threshold level of a user provided by the present inventive subject matter can be applied to an earphone, for example, comprising at least one of an on-ear headphone, a circumaural headphone, an in-ear earphone, and a bone conduction headset.

The description of embodiments has been presented for the purposes of illustration and description as mentioned above. According to the above description, appropriate modifications and alterations may be made to the embodiments, or these modifications and alterations may be obtained from practicing the methods. For example, unless otherwise specified, one or more of the described methods may be implemented via an appropriate apparatus and/or combination of apparatuses. The methods may be implemented by executing stored instructions with one or more logic apparatuses (e.g., processors) in combination with one or more additional hardware elements (such as storage apparatuses, memories, hardware network interfaces/antennas, switches, actuators, or clock circuits). In addition to the sequence described in the present application, the described methods and associated actions may also be performed in parallel and/or simultaneously in various sequences. The described system is essentially illustrative, and may include additional elements and/or omit elements. The subject matter of the present inventive subject matter includes all novel and non-obvious combinations of the various disclosed systems and configurations and additional features, functions, and/or properties.

Examples of one or more embodiments of the present inventive subject matter are described in the following clauses:

Clause 1. A method for tuning an ANC filter based on a hearing threshold level of a user, comprising steps below:
performing, via a hearing test module, a hearing test on the user to obtain hearing threshold level data of the user; and
setting, via a noise cancellation optimization module, the ANC filter based on the hearing threshold level data of the user.

Clause 2. The method according to clause 1, wherein the hearing test comprises broadcasting a test tone to the user at at least one frequency point within at least one frequency range, and wherein the hearing test comprises obtaining the hearing threshold level data of the user from a feedback from the user at the at least one frequency point.

Clause 3. The method according to clause 1 or 2, wherein the user provides the feedback on the hearing threshold level data of the user through a user interface of an App arranged on a user device thereof.

Clause 4. The method according to any one of clauses 1 to 3, wherein the at least one frequency range of the hearing test comprises at least one frequency range within 125 Hz to 8 kHz, wherein the at least one frequency point comprises at least one of 125 Hz, 250 Hz, 500 Hz, 1 kHz, 2 kHz, 4 kHz, and 8 kHz.

Clause 5. The method according to any one of clauses 1 to 4, wherein the method further comprises optimizing, via the noise cancellation optimization module, parameters of the ANC filter within at least one frequency range, in which the user has more sensitive hearing.

Clause 6. The method according to any one of clauses 1 to 5, wherein the method further comprises determining, via the noise cancellation optimization module, a priority of at least one frequency range for ANC optimization based on the hearing threshold level data of the user, and wherein the determining the priority comprises setting at least one frequency range, in which the user has sensitive hearing, as a high priority.

Clause 7. The method according to any one of clauses 1 to 6, wherein the method further comprises selecting, via the noise cancellation optimization module, a set of parameters of the ANC filter from at least one set of pre-customized parameters of the ANC filter based on the priority, wherein the at least one set of parameters of the ANC filter comprises at least one of a filter type, a filter gain, a frequency point, and a quality factor.

Clause 8. The method according to any one of clauses 1 to 7, wherein the method further comprises automatically tuning, via the noise cancellation optimization module, the parameters of the ANC filter based on a real-time LMS adaptive ANC algorithm to achieve optimization.

Clause 9. The method according to any one of clauses 1 to 8, wherein the earphone comprises at least one of an on-ear headphone, a circumaural headphone, an in-ear earphone, and a bone conduction headset.

Clause 10. The method according to any one of clauses 1 to 9, wherein the hearing test is performed in accordance with GB/T 7341 or IEC 60645 standard.

Clause 11. An apparatus for tuning an ANC filter based on a hearing threshold level of a user, comprising:
a hearing test module configured to perform a hearing test on the user to obtain hearing threshold level data of the user; and
a noise cancellation optimization module configured to set the ANC filter based on the hearing threshold level data of the user.

Clause 12. The apparatus according to clause 11, wherein the hearing test module is further configured to broadcast a test tone to the user at at least one frequency point within at least one frequency range, and wherein the hearing test module is further configured to obtain the hearing threshold level data of the user from a feedback from the user at the at least one frequency point.

Clause 13. The apparatus according to clause 11 or 12, wherein the user provides the feedback on the hearing threshold level data of the user through a user interface of an App arranged on a user device thereof.

Clause 14. The apparatus according to any one of clauses 11 to 13, wherein the at least one frequency range of the hearing test comprises at least one frequency range within 125 Hz to 8 kHz, wherein the at least one frequency point comprises at least one of 125 Hz, 250 Hz, 500 Hz, 1 kHz, 2 kHz, 4 kHz, and 8 kHz.

Clause 15. The apparatus according to any one of clauses 11 to 14, wherein the noise cancellation optimization module is further configured to optimize parameters of the ANC filter within at least one frequency range, in which the user has sensitive hearing.

Clause 16. The apparatus according to any one of clauses 11 to 15, wherein the noise cancellation optimization module is further configured to determine a priority of at least one frequency range for ANC optimization based on the hearing threshold level data of the user, and wherein the determining the priority comprises setting at least one frequency range, in which the user has sensitive hearing, as a high priority.

Clause 17. The apparatus according to any one of clauses 11 to 16, wherein the noise cancellation optimization module is further configured to select a set of parameters of the ANC filter from at least one set of pre-customized parameters of the ANC filter based on the priority, wherein the at least one set of parameters of the ANC filter comprises at least one of a filter type, a filter gain, a frequency point, and a quality factor.

Clause 18. The apparatus according to any one of clauses 11 to 17, wherein the noise cancellation optimization module is further configured to automatically tune the parameters of the ANC filter based on a real-time LMS adaptive ANC algorithm to achieve optimization.

Clause 19. The apparatus according to any one of clauses 11 to 18, wherein the apparatus can be applied to an earphone comprising at least one of an on-ear headphone, a circumaural headphone, an in-ear earphone, and a bone conduction headset.

Clause 20. The apparatus according to any one of clauses 11 to 18, wherein the hearing test module is configured to perform the hearing test in accordance with GB/T 7341 or IEC 60645 standard.

Clause 21. A non-transitory computer-readable medium comprising an instruction, wherein the instruction, when executed by one or more processors, causes the one or more processors to implement the method for tuning an ANC filter based on a hearing threshold level of a user according to any one of clauses 1 to 10.

The selection of the terms used herein is intended to best explain the principles and practical applications of the embodiments or the improvements to technologies available on the market, or to enable other persons of ordinary skills in the art to understand the embodiments disclosed herein.

In the above, reference is made to the embodiments presented in the present disclosure. However, the scope of the present disclosure is not limited to the specifically described embodiments. On the contrary, any combination of the above features and elements, whether involving different embodiments or not, is contemplated to implement and practice the contemplated embodiments.

Moreover, although the embodiments disclosed herein may achieve advantages over other possible solutions or over the prior art, whether or not a given embodiment achieves a particular advantage does not limit the scope of the present disclosure. Therefore, the above aspects, features, embodiments, and advantages are merely illustrative and are not considered as elements or limitations of the appended claims, unless otherwise expressly recited in the claims.

Although the above content is directed at the embodiments of the present disclosure, other and further embodiments of the present disclosure may be devised without departing from the basic scope of the present disclosure, and the scope of the present disclosure is determined by the appended claims.

1. A method for tuning an ANC filter based on a hearing threshold level of a user, comprising steps below:
performing, via a hearing test module, a hearing test on the user to obtain hearing threshold level data of the user; and
tuning, via a noise cancellation optimization module, the ANC filter based on the hearing threshold level data of the user.

2. The method according to claim 1, wherein the hearing test comprises broadcasting, via the hearing test module, a test tone to the user at at least one frequency point within at least one frequency range, and wherein the hearing test comprises obtaining the hearing threshold level data of the user from a feedback from the user at the at least one frequency point.

3. The method according to claim 2, wherein the user provides the feedback on the hearing threshold level data of the user through a user interface of an App arranged on a user device thereof.

4. The method according to claim 2, wherein the at least one frequency range of the hearing test comprises at least one frequency range within 125 Hz to 8 kHz, wherein the at least one frequency point comprises at least one of 125 Hz, 250 Hz, 500 Hz, 1 kHz, 2 kHz, 4 kHz, and 8 kHz.

5. The method according to claim 1, wherein the method further comprises optimizing, via the noise cancellation optimization module, parameters of the ANC filter within at least one frequency range, in which the user has more sensitive hearing.

6. The method according to claim 5, wherein the method further comprises determining, via the noise cancellation optimization module, a priority of at least one frequency range for ANC optimization based on the hearing threshold level data of the user, and wherein the determining the priority comprises setting at least one frequency range, in which the user has sensitive hearing, as a high priority.

7. The method according to claim 6, wherein the method further comprises selecting, via the noise cancellation optimization module, a set of parameters of the ANC filter from at least one set of pre-customized parameters of the ANC filter based on the priority, wherein the at least one set of parameters of the ANC filter comprises at least one of a filter type, a filter gain, a frequency point, and a quality factor.

8. The method according to claim 6, wherein the method further comprises automatically tuning, via the noise cancellation optimization module, the parameters of the ANC filter based on a real-time LMS adaptive ANC algorithm to achieve optimization.

9. The method according to claim 7, wherein the method is applied to an earphone comprising at least one of an on-ear headphone, a circumaural headphone, an in-ear earphone, and a bone conduction headset.

10. The method according to claim 1, wherein the hearing test is performed in accordance with GB/T 7341 or IEC 60645 standard.

11. An apparatus for tuning an ANC filter based on a hearing threshold level of a user, comprising:
a hearing test module configured to perform a hearing test on the user to obtain hearing threshold level data of the user; and
a noise cancellation optimization module configured to tune the ANC filter based on the hearing threshold level data of the user.

12. The apparatus according to claim 11, wherein the hearing test module is further configured to broadcast a test tone to the user at at least one frequency point within at least one frequency range, and wherein the hearing test module is further configured to obtain the hearing threshold level data of the user from a feedback from the user at the at least one frequency point.

13. The apparatus according to claim 12, wherein the user provides the feedback on the hearing threshold level data of the user through a user interface of an App arranged on a user device thereof.

14. The apparatus according to claim 12, wherein the at least one frequency range of the hearing test comprises at least one frequency range within 125 Hz to 8 kHz, wherein the at least one frequency point comprises at least one of 125 Hz, 250 Hz, 500 Hz, 1 kHz, 2 kHz, 4 kHz, and 8 kHz.

15. The apparatus according to claim 11, wherein the noise cancellation optimization module is further configured to optimize parameters of the ANC filter within at least one frequency range, in which the user has more sensitive hearing.

16. The apparatus according to claim 15, wherein the noise cancellation optimization module is further configured to determine a priority of at least one frequency range for ANC optimization based on the hearing threshold level data of the user, and wherein the determining the priority comprises setting at least one frequency range, in which the user has sensitive hearing, as a high priority.

17. The apparatus according to claim 16, wherein the noise cancellation optimization module is further configured to select a set of parameters of the ANC filter from at least one set of pre-customized parameters of the ANC filter based on the priority, wherein the at least one set of parameters of the ANC filter comprises at least one of a filter type, a filter gain, a frequency point, and a quality factor.

18. The apparatus according to claim 16, wherein the noise cancellation optimization module is further configured to automatically tune the parameters of the ANC filter based on a real-time LMS adaptive ANC algorithm to achieve optimization.

19. The apparatus according to claim 17, wherein the apparatus can be applied to an earphone comprising at least one of an on-ear headphone, a circumaural headphone, an in-ear earphone, and a bone conduction headset.

20. The apparatus according to claim 11, wherein the hearing test module is configured to perform the hearing test in accordance with GB/T 7341 or IEC 60645 standard.
